(19) United States
(12) Patent Application Publication
(10) Pub. No.: US 2007/0100829 A1
(43) Pub. Date: May 3, 2007

(54) CONTENT MANAGER SYSTEM AND METHOD

(76) Inventors: J. Vance Allen, Denver, CO (US); Sarah Bradford, Denver, CO (US); Brian Burson, Highlands Ranch, CO (US); Brandon Fleisher, Littleton, CO (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 11/163,670

(22) Filed: Oct. 26, 2005

(51) Int. Cl. G06F 17/30

(52) U.S. Cl. 707/9

(57) ABSTRACT

The invention provides a content management system for on-line educational platforms, including a central content repository. The invention provides version control, search capabilities, content referencing and copying capabilities, content usage tracking, user role type permissions controls, content locking, and authoring and delivery templates. The system and method track and record content usage and student activity relative to archived content versions. The system and method provide efficient means to author, develop, control, organize, distribute, reuse, and repurpose educational content across multiple educational courses and organizations.

### FIELD OF INVENTION

The invention generally relates to an on-line educational content repository and management system and method.

### BACKGROUND OF INVENTION

As the number of accredited online educational institutions increases and online courses offered by established institutions increases, administrators and educators are often demanding more efficient and convenient content and course management tools. Online education programs usually include large volumes of course content and may not effectively standardize shared content across courses or adequately control the creation and editing of standardized content. For example, in existing course management systems, content copied from one course to another course is independent, in that once content is copied to multiple courses, it is not “shared” by those courses. Rather, the content becomes unique to that course as the content is modified. The unique content often results in a loss of content version control and compounded redundancy of content requiring additional content maintenance and storage. In addition, existing systems typically provide content authoring capabilities only within a course instance, without a sufficient established workflow process for content creation, editing, approval, and tracking of content usage. Furthermore, conventional systems typically store content items as files associated with individual course sections, providing little or no control over the independent content items across multiple course sections. For example, existing systems often lack the capability to lock mandatory content within multiple course sections to ensure that such content is included, unaltered, in those course sections.

Accordingly, a need exists for a system and method for providing an efficient system and method to author, develop, control, organize, distribute, lock, update, reuse, and/or re-purpose educational content across courses and organizations.

### SUMMARY OF INVENTION

The invention facilitates, through a central content repository, management of content items separate from the ultimate content delivery mechanisms. Content management includes, for example, organizing, categorizing, and structuring information for flexible storage, publication, and editing. Content is stored as individual or associated components tagged and indexed using metadata and taxonomy to allow users to efficiently search, copy, edit and reuse content, shortening the development lifecycle for course materials. Central content maintenance and workflow management tools provide for version control and control over content creation and editing workflows based on a hierarchy of user roles and rights. Content may be organized into sub-repositories by author, course, institution, and the like with various permissions or rights assigned to individual users or user role types. By processing and controlling the creation, updating, and publishing of content at a central content repository, content may be standardized at a granular level and efficiently deployed and updated through multiple delivery channels. Content delivery templates and multimedia object tools may be used to reference or copy stored content for use within any number of courses.

Various embodiments include advanced authoring tools having a content frame style manager, content page layout templates and multimedia object templates facilitating customization of content delivery with, for example, branding or other themed layouts. Content controls include lockdown features ensuring that locked content is included and remains unaltered within designated courses. In addition to version and rollback controls, various embodiments provide for content usage tracking within any number of courses across an educational platform, as well as student activity tracking and long term archival of user activity relative to stored content versions. Accordingly, various features and tools of the system and method provide for a content repository, content searching, version control, content authoring, reporting on content usage, role based access and editing control, and/or content publishing.

### BRIEF DESCRIPTION OF THE DRAWINGS

Additional embodiments of the invention will become evident upon reviewing the non-limiting embodiments described in the specification and the claims taken in conjunction with the accompanying figures, wherein like reference numerals denote like elements, and

FIG. 1 is a diagram illustrating an exemplary network configuration for creating and delivering on-line educational content in accordance with an exemplary embodiment of the present invention;

FIG. 2 is a flow chart of an exemplary content workflow in accordance with an exemplary embodiment of the present invention;

FIG. 3 is a diagram illustrating an exemplary content usage tracking system in accordance with an exemplary embodiment of the present invention; and

FIG. 4 is a flow chart of an exemplary student activity tracking routine in accordance with an exemplary embodiment of the present invention.

### DETAILED DESCRIPTION

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, other embodiments may be realized and logical and other changes may be made without departing from the spirit and scope of the invention. Thus, the detailed description herein is presented for purposes of illustration only and not of limitation. For the sake of brevity, conventional data networking, application development and other functional embodiments of the systems (and components of the individual operating components of the systems) may not be described in detail herein.

The present invention comprises a web-based content management system (“CMS”) including a central content repository and various user interfaces and tools for authoring, editing, copying, publishing, locking, tracking, and/or managing content across an on-line educational platform. Content includes any piece or collection of information that can be published to a delivery mechanism, such as, for example, text, a JPG image, MP3 audio file, a flash movie, document, threaded discussion topic, text for an assessment answer, outline, archived lecture, instructor feedback, student submission, spreadsheet, course title, course description, assignment, exam, quiz, skill test, syllabus, journal entry or calendar entry. For example, a content item may be an individual picture, or it may be an entire multimedia presentation. A content item may be associated with additional metadata defining the properties, context, or purpose of the content in a given application, such as, for example, course title, author, contributor, associated learning outcome/objective, key words, content area, discipline, activity, and the like. “Learning outcomes” includes, for example, a unit of measure or standard referring to the understanding or acquisition of defined knowledge or skill sets. In one embodiment, learning outcomes include comprehension of a learning content item, acquisition of a standardized skill, mastery of a standardized learning objective and the like. Content can be assembled or defined for any level within a program hierarchy, such as, for example, for a course, unit, module, content file, topic, page, term, campus, or other nodal unit. Content may include multiple formats, for example images, text, and sound. Content may be managed, copied, searched, or locked as an individual granular content item, or as a group of content items, for example as a unit or chapter within a course.

As used herein, the terms “user,” “author,” “publisher,” “administrator,” “educator,” “teaching assistant,” “institution,” “participant,” “client,” or “campus” may be used interchangeably with each other, and each shall mean any person, entity, machine, hardware, software and/or business. In one embodiment, an author is one who creates a content item for inclusion in the CMS or for use in a course. A publisher provides prepared content for use by educational programs. An administrator approves content for inclusion in the CMS and works with authors and publishers to control content versions and updates. Instructors select content for inclusion in courses and may also have authoring access to the CMS within a course. Varying levels of access may be granted users based on various user role types and user rights. For example, an author role type may have full create, write, and edit access while a teaching assistant role type may only have access rights within a given course and limited authoring rights to create quizzes or the like within that course. Administrative role types may have audit or read access to review content usage and student activity reports.

The CMS allows content publishers, administrators, instructors and staff to create, manage, edit, delete, search for and/or share content across multiple courses at, for example, a macro level higher than the individual course instances. Various embodiments provide for referencing or tying of copied content to standardized content subject to centralized version, rollback, and authoring control mechanisms. Various other embodiments allow users to make a copy of content for independent version control within a given course instance or program level. Accordingly, users may use shared content with updates published globally, or may make an independent copy of content for local editing within a given course.

An exemplary embodiment of the CMS includes a content usage tracking and reporting mechanism enabling administrators, authors, publishers, and other system users to determine where content is utilized throughout a program or institution and across multiple institutions. For example, a publisher may easily determine which courses leverage a given content item, facilitating efficient management of digital rights in publisher content. Another exemplary embodiment provides centralized management of content from creation through delivery, including history archives to permit reversion of content to prior versions.

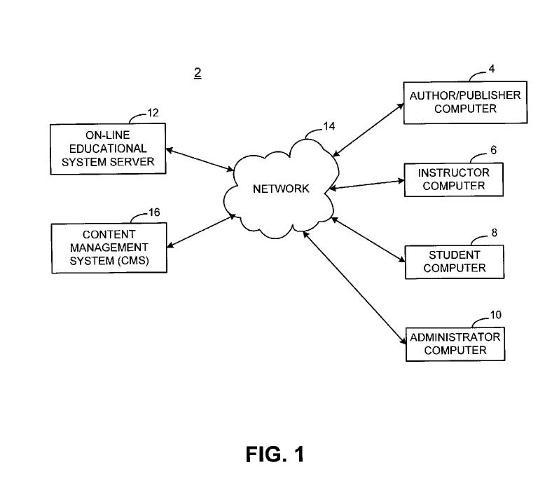

Turning now to the drawings, FIG. 1 is a diagram illustrating an exemplary network configuration 2 for authoring, editing, managing, and/or delivering content within an on-line educational platform. Network configuration 2 includes an author/publisher computer 4, instructor computer 6, student computer 8 and an administrator computer 10 in communication with an on-line educational system server 12 and a CMS 16 via a network 14, such as the Internet. On-line educational system server 12 delivers content stored on CMS 16 for use by instructors at instructor computer 6 and students at student computer 8. Instructors at instructor computer 6 and students at student computer 8 may share content and interact with each other and with on-line educational system server 12 via network 14. Examples of on-line educational system server 12 and of a system for delivering courses on-line are described in U.S. Pat. No. 6,470,101, which is hereby incorporated by reference. CMS 16 or system server 12 may be further connected to any number of databases or networked resources, such as a digital library.

Exemplary computers 4, 6, 8, and 10 include personal computers, laptops, notebooks, hand held computers, set-top boxes, personal digital assistants, cellular telephones, transponders, and any other device suitable for delivery of content. In an embodiment, CMS 16 may be incorporated into on-line educational system server 12 as a content management application implemented as computer software modules loaded onto system server 12. Similarly, CMS software modules may also be loaded onto a client computer or any of computers 4, 6, 8, or 10. Alternatively, the client computer may not require any or only require very little additional software to support the content management system. For example, the content management application may be remotely hosted as a stand alone CMS 16 and accessed by any of the computers or servers described herein to create, edit, or access content.

As will be appreciated by one of ordinary skill in the art, the present invention may be embodied as a customization of an existing system, an add-on product, upgraded software, a stand alone system, a distributed system, a method, a data processing system, a device for data processing, and/or a computer program product. Accordingly, the present invention may take the form of an entirely software embodiment, an entirely hardware embodiment, or an embodiment combining embodiments of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: course data; content data; institution data; and/or like data useful in the operation of the present invention. As those skilled in the art will appreciate, user computers 4, 6, 8, and 10 include an operating system (e.g., Windows NT, 95/98/2000, OS2, UNIX, Linux, Solaris, MacOS, etc.) as well as various conventional support software and drivers typically associated with computers. User computers may include any suitable personal computer, network computer, workstation, minicomputer, mainframe or the like. User computers 4, 6, 8, and 10 may be in a home, business, or educational institution environment with access to network 14. In an exemplary embodiment, access is through the Internet through a commercially-available web-browser software package.

As used herein, the term “network” 14 shall include any electronic communications means which incorporates both hardware and software components of such. Communication between users or system components in accordance with the present invention may be accomplished through any suitable communication channels, such as, for example, a telephone network, extranet, intranet, Internet, point of interaction device, personal digital assistant (e.g., Palm Pilot®), cellular phone, kiosk, online communications, satellite communications, off-line communications, wireless communications, transponder communications, local area network (LAN), wide area network (WAN), networked or linked devices, keyboard, or any other suitable communication or data input modality.

The invention may be implemented with TCP/IP communications protocols or with IPX, Appletalk, IP-6, NetBIOS, OSI or any number of existing or future protocols. If network 14 is in the nature of a public network, such as the Internet, it may be advantageous to provide firewalls, encryption, or other suitable security measures. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to network 14 via data links which includes, for example, a connection to an Internet Service Provider (ISP) over a local loop as is typically used in connection with standard modem communication, cable modem, Dish networks, ISDN, Digital Subscriber Line (DSL), or various wireless communication methods, see, e.g., GILBERT H_{ELD}, UNDERSTANDING DATA COMMUNICATIONS (1096), which is hereby incorporated by reference. It is noted that network 14 may be implemented as any type of network, such as, for example, an interactive television (ITV) network. Moreover, the system contemplates the use, access, viewing, copying, or distribution of any content, information, goods or services over any network having similar functionality described herein. Additionally, as used herein, “data” may include encompassing information such as commands, queries, files, data for storage, and the like in digital or any other form. The invention contemplates uses in association with web services, utility computing, pervasive and individualized computing, security and identity solutions, autonomic computing, mobility and wireless solutions, open source, biometrics, grid computing and/or mesh computing.

Content is stored in a central repository database within or accessible by CMS 16. The central repository may include or be organized into any number of sub-repositories, organized, for example by institution, course, author, or any other relevant node or criteria. Alternatively, CMS 16 may accommodate allocation of content between the central repository and locally stored personal repositories. Allocation of content to a personal repository may be used to restrict access and permissions to such content. Any databases discussed herein may include relational, hierarchical, graphical, or object-oriented structure and/or any other database configurations. The databases may be organized, for example, as data tables or lookup tables. Each data record may be a single file, a series of files, a linked series of data fields or any other data structure. Association of data, whether manual or automatic, may be accomplished through any data association technique known or practiced in the art. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type or format of data in the key field. The data corresponding to the key field in each of the linked data tables is preferably the same or of the same type. However, data tables having similar, though not identical, data in the key fields may also be linked by using AGREP, for example. Data sets may be stored using any suitable technique, including, for example, storing individual files using an ISO/IEC 7810-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7810-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

As stated herein, in various embodiments of the present invention, the data may be stored without regard to a common format. However, in one exemplary embodiment of the present invention, the data set (e.g., BLOB) may be annotated in a standard manner when included for manipulating the data. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer, publisher, or owner of the data. In one example, the first three bytes of each data set BLOB may be configured or configurable to indicate the status of that particular data set; e.g., LOADED, INITIALIZED, READY, BLOCKED, REMOVABLE, or DELETED.

The data set annotation may also be used for other types of status information as well as various other purposes. For example, the data set annotation may include security information establishing access levels for various user roles. The access levels may, for example, be configured to permit only certain users, individuals, levels of employees, companies, or other entities to access data sets, or to permit access to specific data sets. Furthermore, the security information may restrict or permit only certain actions such as accessing, viewing, copying, modifying, publishing and/or deleting data sets. In one example, the data set annotation indicates that only the data set owner or author is permitted to delete a data set, various identified users may be permitted to access the data set for reading, and others are altogether excluded from accessing the data set. However, other access restriction parameters may also be used allowing various entities to access a data set with various permission levels as appropriate. For example, content may be organized into sub-repositories by author, node, course, institution, campus and the like with various permissions or rights assigned to individual users, user role types, or user groups.

One skilled in the art will also appreciate that, for security reasons, any databases, systems, devices, servers or other components of the present invention may consist of any combination thereof at a single location or at multiple locations. Additional available security features include firewalls, access codes, encryption, decryption, data compression, and the like. Firewalls may include any hardware and/or software suitably configured to protect system components and/or enterprise computing resources from users of other networks. Further, a firewall may be configured to limit or restrict access to various systems and components behind the firewall for web clients connecting through a web server. Firewalls may reside in varying configurations including Stateful Inspection, Proxy based and Packet Filtering among others. Firewalls may be integrated within a web server or any other system components or may further reside as a separate entity.

The computers discussed herein may include a suitable website or other Internet-based graphical user interface which is accessible by users. Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like.

Computer program instructions may be loaded onto a general purpose computer, special purpose computer, or other programmable data processing apparatus to produce a machine, such that the instructions that execute on the computer or other programmable data processing apparatus create means for implementing the described functions and features. These computer program instructions may also be stored in a computer-readable memory that may direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus include steps for implementing the functions of the present invention.

Any steps or functions described herein may be implemented by either special purpose hardware-based computer systems that perform the specified functions or steps, or suitable combinations of special purpose hardware and computer instructions. Practitioners will appreciate that the steps described herein may include the use of windows, web pages, web forms, popup windows, prompts and the like. It should be further appreciated that multiple process steps may be combined into single steps, or single steps may be separated into multiple steps for the sake of simplicity.

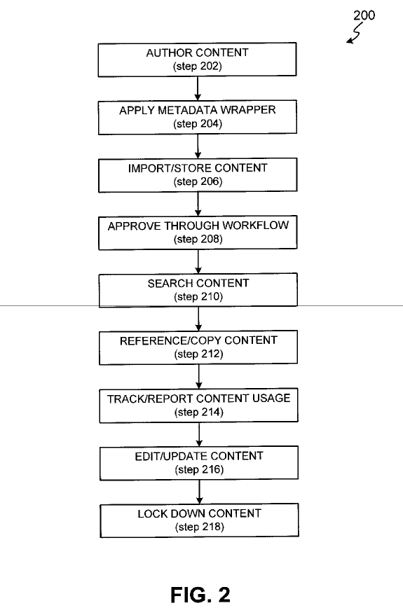

FIG. 2 illustrates an exemplary content workflow 200 implemented through an exemplary CMS 16. Content may be authored within CMS 16 by authorized user role types using various content templates. (step 202) For example, a content author such as an instructor may create content within various templates, for example, text within a lecture template or an examination question within an examination template. During the content authoring process, content may be saved within CMS 16 in draft form, remaining hidden from other users until the author publishes the content. Alternatively, an instructor may prepare various content items offline for inclusion in a course unit and then may upload the content items or the entire course unit to CMS 16, for example as a single zip file. As described below, prepared content may be imported from a publisher or from a third-party content authoring application. (step 206) Once content is authored or imported, it may then be made available or “published” for use by instructors or other users in assembling content into course materials.

In one embodiment, content authoring is the process of creating new content, while content assembling is the process of leveraging existing content from the central repository and organizing that leveraged content according to certain delivery goals and objectives. For example, an instructor may access a repository search engine to search for relevant content based on metadata or course title and add selected content to any number of locations within a course, any number of course units or any number of courses. The instructor may preview content, content metadata, content usage, and content permissions prior to adding the content to a course. For example, a search window may display active links for search results following a metadata or course title search and additional links for metadata, usage, and permission information associated with the content. Selection of a search result link provides a preview of the selected content. Selection of the metadata link displays key word, description, author or other searchable information fields associated with the content. Selection of the usage link displays a list of the various instances of the content within the user's node or institution. Selection of the permissions link displays information about the author/owner, locking status, and rights assigned to various nodes.

To add existing content to a course, a user identifies relevant content by searching metadata and creating a reference within a course to selected content within the repository. For example, an instructor may select a content item in a first drop down menu and then add the content item to an existing course unit by selecting the unit location from a second drop down menu. Since any number of references may be created to master content in the central repository, content may be universally updated simply by publishing updates made to the master content. Permission to edit central content and publish updates may be limited to the content author or may be assigned to any number of role types or organizational nodes. In various embodiments, users may, instead, create an independent copy of content in a personal sub-repository for independent use in a course. Content searches may be performed simultaneously within the central repository and a user's personal sub-repository. Any additional course structure, settings, metadata, and the like may also be referenced or copied.

Users may use templates available on the CMS both to author and to assemble content for delivery within a course. An exemplary authoring template defines the required and optional meta-data useful in properly indexing and managing content in the central repository. The central repository stores both the content file itself, as well as the meta-data defined for the content. Collections or sets of content items and meta-data may be stored in any suitable manner within the repository. Content items such as a movie, image, or text, may be assembled within a delivery template.

Content is wrapped with a metadata wrapper including, for example, certain SCORM 1.2 compliant meta-data defining or identifying the content. Optional meta-data fields may be available within the wrapper for any other pertinent information about the content, such as, for example, licensing information for publisher content including price, start/stop dates, and publisher identity. The content author or owner may supply metadata during the authoring process or such metadata may be added later, for example during a data import process. Likewise, disaggregation, migration, or import tools may automatically populate metadata through data mining and inference functionalities during conversion and/or import of content into the CMS. By reducing content files to a granular level of individual content items, it may be more effectively delivered to multiple delivery channels, shortening the content product development lifecycle.

As described above, content may be authored within the CMS or may be imported or migrated into the CMS from other platforms or formats (step 206). In one embodiment, the CMS facilitates uploading of related files as a bundle or zipped package. The CMS may prompt the user to identify a home page within the bundle as a starting point for navigation between the bundled files. Various CMS embodiments may accept any number of files and formats including, for example, SCORM-compliant zip files, IMS-compliant files, AICC-compliant files, Microsoft Office files, Macromedia multimedia files, and Adobe files. During an import process, content files are disaggregated and dissected into distinct granular content items, which are then wrapped with appropriate metadata. For example, an existing course unit may be broken down into individual content items and content items wrapped with metadata defining content properties such as the course title and author. Metadata may also be associated with content during the content authoring process. Once content has been wrapped with appropriate metadata, it may then be imported into the CMS repository to be made available to authors for inclusion in various delivery templates. The content may be viewed, played, or otherwise accessed or acted upon within the delivery templates. Similarly, content may be exported from the CMS into a SCORM 1.2-compliant zip file for portability to other SCORM 1.2-compliant systems, delivery channels, software, applications, or hardware such as, for example, wireless devices or other web-based or non-web-based delivery mechanisms. By providing export capabilities, content developed by an instructor within the CMS may be exported for later use off-line or on a third-party platform.

In one CMS embodiment, administrative role types establish an approval workflow for any number of content types or delivery mechanisms (step 208). For example, authoring rights to a certain course may be limited to certain users, with any new content requiring approval from an administrative user type prior to inclusion in the CMS or in a course. Workflow management may include tools to partially or fully automate the flow of the content approval and status tracking processes. Workflow tools may integrate with an SMTP email protocol to automatically inform an email address of content that is awaiting approval, status changes, or of new work assignments.

For example, multiple users may be responsible for authoring, assembling, or otherwise contributing to content. Individual users or user types may receive various rights to content, such as, for example, rights to author, edit, approve, publish, delete, view, copy, manage, audit, and the like. Users may also request rights to content through the workflow process. A project manager may use the workflow tools to assign tasks to other users and to manage the overall content production process. Auto-generated emails notify users of new assignments as well as provide reminders as task milestone dates approach. The workflow process facilitates securing proper approvals for a task prior to task completion. The workflow may be used to define contributor resources as either individual contributors or groupings of individual contributors, as well as to define physical resources such as an audio/video studio or other equipment. Once content is approved, it is stored in the CMS central repository and is published for use by others according to their role types and access rights. A content owner may generate and publish content to multiple courses and update content in one or more places.

A user seeking to assemble content may then access the central content repository from within a delivery template to locate content items via a CMS search engine (step 210). Users may conduct searches based on metadata properties of that content and/or on the content itself. Authorized users may also use the search engine to locate content in a maintenance mode to edit, modify, or delete existing content. For example, Professor Jones, who teaches Business 101 within the Business department, may only have rights to search for content within the Business department repository for the respective institution. Once content is located, the user can choose to assemble content by creating a reference to the content from within the delivery template or by creating a duplicate of the content to be independent to, or customized for, a particular course or context (step 212).

In an exemplary content assembly process, a user seeking to create a course, or to add content to a course, accesses the CMS and searches for available content by topic, author, publisher, learning outcome, keyword, or other relevant criteria. The user then selects content for inclusion in a delivery template within a course shell. The selected content is then included within the template as a reference to the original content instance. For example, the user may select content from within a dropdown menu and then select a course or course unit to which the content is to be added. Subsequent content updates are thus automatically published to all referenced content instances. Alternatively, a content publisher may provide content updates on a selective basis or may provide notices when updates are available. Similarly, users may receive advanced notifications of available updates and may then accept, reject, or defer content updates. Upon, rejecting published updates a user may be requested to save the relevant content to the user's personal repository, rendering the content independent of future central updates. Alternatively, a user may opt to include an independent copy of content into a course for local editing. Edits may then be made within a given course with the edits identified uniquely to that course.

Users may create content within delivery templates or other authoring tools in the event that the user is not able to locate the desired content in the CMS repository. These authoring tools may include tools to generate, for example, textual content, threaded discussion topics, syllabus content, multi-media content or assessment content. The CMS may be expandable to allow future authoring tools to “plug-in” to the CMS architecture to support additional content and delivery mechanism types.

Delivery templates may be used to author content, assemble content, and/or deliver content to users. In one embodiment, an exemplary delivery template is a student dashboard providing a number of different tools or features such as, for example, a style manager for designing the user interface “skin”, listing of enrolled courses, listing of current grades in currently enrolled courses, assignments due in currently enrolled courses, notices from currently enrolled courses, course catalog listings, student portfolio, enroll/un-enroll options, Instant Messenger, calendar, bookstore, library, and search options.

Delivery templates enable a user to define the presentation “layer” for a page, display, navigation frame, or content frame including a variety of styles, skins, backgrounds, fonts, colors, standards, and layouts for text and multimedia displays. Delivery templates may also be used to customize content appearance, for example, to include private branding. For example, standardized publisher content may be assembled into branded delivery templates throughout an on-line college platform. Thus, template themes may be updated universally without altering the content assembled within those templates. A delivery template or content page layout may include, for example, text, images, audio/video segments, interactions, threads, collaborations, or any combination of the above. Templates may be tailored to certain users (i.e., student, author, instructor, administrator), to certain grade levels, or to various languages and the like.

Various embodiments include multimedia object templates allowing course authors to easily create interactive, multimedia content items or student activities. For example, a drag and drop template allows instructors to create a multi-media exercise simply by importing images by name and identifying the correct placement for each image by dragging and dropping the images or other multi-media objects within the template.

Various CMS embodiments provide tracking of content usage by course, term, campus, or according to any other relevant node or criteria (step 212). For example, a publisher may desire to track the scope of distribution and frequency of use of licensed content across multiple on-line education service provider platforms. In another embodiment, content usage is tracked per student, tying content version data to student activity data within a student portfolio. Student portfolios enable students and administrators to view reports of student activity and to access the correct archived content version upon which that student activity was based.

Content usage reports may be generated by a content author, administrator, or faculty member to learn about relevant content usage characteristics. For example, the content author may identify all of the locations the content is leveraged to understand how a modification to the content might impact different users. The administrator may monitor how frequently and by whom a certain content item is used, for example, to determine if content is effective and useful, if licensing models apply to the content, and the levels of demand for the content. Various reports may include storage requirements and formats for content, or may include any metadata information such as the content author or contributors. Thus, usage reporting tools enable a user to determine the number of instances of a specific content and exactly where that content is being used. Usage reporting also facilitates efficient maintenance of content within a variety of applications and templates. Additionally, usage tracking facilitates efficient management of publisher intellectual property rights and fees.

Content edits and updates are processed in the central content repository and deployed universally or selectively to courses or other delivery channels leveraging that content (step 216). For example, edits may be deployed only to certain courses or to certain institutions or subscribers. Content edit and update rights may be limited to certain user role types to restrict or limit user access to CMS content accordingly within a course, group of courses, or program. Similarly, users may receive limited rights to check in/out content, copy content, and access previous content versions, and the like. A user with the role or access rights of content owner may update content within the CMS repository, with the corresponding changes being reflected in all content instances throughout various courses and programs leveraging that content. In one embodiment, the CMS provides the content owner a summary of how modifications to content could impact end users by identifying where content is being leveraged throughout the various educational platforms. Maintaining the content in a central repository allows update “pushes” of that content through the various delivery channels. Updated content may be viewable, in substantially real-time, to all users that have the role(s) and right(s) to view that content. Alternatively, established workflow processes may require a publish step to indicate that content is “ready” or viewable for assembly into delivery templates. This additional publish step may be incorporated into any of the workflow management, version control, and content management features of the CMS already described herein.

Content may be locked within designated courses to ensure that it remains a mandatory part of such courses and to ensure content consistency across course sections, geographic locations, and delivery modalities. For example, an administrator may lock content covering essential topics by requiring that such content be accessed in a particular sequence. Content or content groups may be fully locked within a course, preventing unauthorized editing, moving, hiding, publication, deletion, or copying, or content may be partially locked preventing unauthorized deletion. Any number of access, editing or similar rights may be granted based on the degree of locking applied to given content. Locking controls may be in addition to rights and permissions granted through role assignments. This locking feature enables institutions to demonstrate to accreditation bodies that course content is centrally controlled and consistent across courses. While content may be unlocked, permissions rules still govern content editing within the CMS to prevent unauthorized content alterations. For example, the CMS workflow may require that content be checked-in and out of the content repository to ensure that only one authorized user is modifying certain content at a given time and that content is not over-written by another user. Version history records and content archives facilitate roll-back of content to a previous version.

Various exemplary CMS use scenarios will now be described with regard to exemplary role types and functions. An instructor may view a directory of, or search for, published content applicable to the instructor's course. Searches may be based on author, publisher, learning outcome, taxonomy, keywords, development dates, and the like. The instructor may author new content for the course and submit the content to the CMS workflow for approval and publication for use in other courses. The instructor may likewise request to unpublish or delete submitted content. The instructor may assemble content into course content delivery templates using reference or copy functions. Copied content that has not been locked down may then be edited to suit the course. Referenced content remains shared with the original content so that updates are automatically reflected in the course templates. Alternatively, the instructor may selectively accept or reject updates to referenced content based on update notifications provided through the CMS, for example, by email. Instructors may also search for and view available updates for content. Content and content templates may be shared between courses. Instructors may then generate content usage reports within the course to determine content effectiveness over time relative to student responses or performance, and may choose to share usage reports with instructors of other courses. Usage reporting allows instructors and administrators to assess content usage and tailor content and content delivery to achieve desired learning outcomes, such as a certain student proficiency or student retention for the course.

Administrators may establish the rights granted to various users and role types as well as establish workflow processes for content. Administrators may also lock down content within courses to ensure that an instructor covers that content within the course. Administrators generate content usage reports and remove or archive content and schedule publication of new content. An administrator may choose to view course content or other instruction material through a student, instructor, or administer interface view.

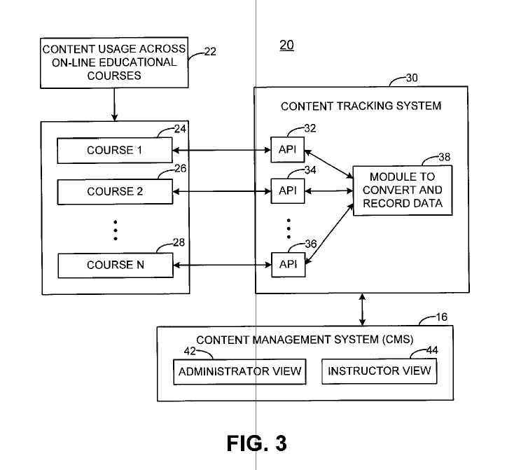

FIG. 3. illustrates an exemplary content usage reporting system configuration 20 for compiling content usage data and student activity data from disparate courses and course tools. During participation in on-line educational courses 24, 26, and 28, students view, interact with, and generate content. The presence of content within a course and student interaction with that content are referred to collectively as content usage 22. Courses 24, 26, and 28 include a variety of course tools or content delivery mechanisms. Exemplary course tools and content delivery mechanisms include, for example, a lecture, an exam, document sharing, student journal, student portfolio, and chat dialogue. Exams may include any form of assessment tool or assessment content, such as tests, quizzes, or skill set evaluations. Document sharing tools allow content to be posted, uploaded and accessed or downloaded by multiple users.

A content usage tracking engine 30 tracks the deployment of content through various delivery mechanisms and course tools in multiple courses. For example tracking engine 30 enables reporting of course locations or course instances referencing a given content item. Tracking engine 30 may also be used to monitor and record student activity relative to given content. User activity may be tracked by the minute according to content, course tool, or by any other relevant criteria, or metric. For example, tracking engine 30 may record the amount of time spent by a user relative to any number of content items. Student performance and content efficacy may be measured relative to learning outcomes through tracking of user activity relative to content items and learning outcomes associated through metadata with those content items. Tracking engine 30 may cooperate with or be integral to CMS 16. An exemplary tracking engine 30 includes application programming interfaces (APIs) 32, 34, and 36, or any other type of hardware or software element, to monitor content usage 22 within courses 24, 26, and 28. Tracking engine 30 includes a module(s) 38 for suitably receiving, converting and/or compiling information from APIs 24, 26, and 28 for use by CMS 16. In this example, CMS 16 includes an administrator interface view 42 and an instructor interface view 44. Authorized users may access CMS tools and features from within the course environment or through administrative CMS interfaces.

Administrator interface view 42 displays content usage 22 across the educational platform while instructor interface view 44 displays student activity for multiple students within the courses taught by that instructor. Tracking of both content usage and student activity allows administrators to correlate content, student activity, and student performance to identify effective content and delivery mechanisms, or perhaps quality publishers or to generate any number of useful performance metrics. An example of an on-line education system, including content delivery mechanisms and course tools, is included in U.S. Pat. No. 6,470,101, which is incorporated herein by reference.

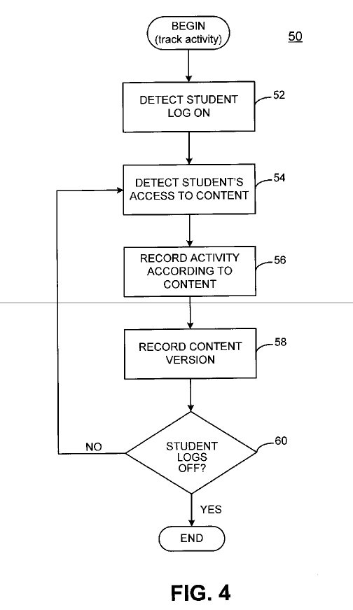

FIG. 4 is a flow chart of an exemplary student activity tracking routine 50. Routine 50 may be implemented as software modules, for example, for execution by system server 10. In routine 50, tracking engine 30 detects and logs a student log on (step 52). A student may access or log onto system server 10 or other remote server providing on-line educational courses using a web browser. Tracking engine 30 further detects the student's access to particular content, content delivery mechanism, or course tools as part of the student's participation in on-line educational courses 24, 26, or 28 (step 54), and further records student activity relative to courses 24, 26, or 28 (step 56). Tracking engine 30 records content version data for content accessed during student activity (step 58). Recording content version data along with student activity data, for example, in an electronic student portfolio, enables users to retrieve the correct content version corresponding to a student activity data record. Tracking engine 30 continues to record student activity until the student logs off (step 60). Routine 50 may be executed simultaneously for multiple students across different courses.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention.

What is claimed is:

1. A web-based content management system comprising:
a central content repository for storing content and associated content metadata for use by a plurality of users;
a content repository search engine configured to facilitate searches of at least one of said content and said content metadata;
a permissions system configured to facilitate central management of user rights in at least one of content creation, content editing, content import, and content delivery within said content repository;
a content delivery template configured to facilitate at least one of content authoring and content assembly within a course, wherein said content assembly includes establishing references to said educational content in said central content repository; and
a content usage tracking engine configured to monitor instances of said content within a plurality of courses.

2. The system of claim 1, wherein said content usage tracking engine is further configured to monitor user activity relative to said instances of said content.

3. The system of claim 1, wherein said repository is configured to facilitate publication of updates to said content in said plurality of courses through a plurality of references to said content in said repository.

4. The system of claim 1, further comprising a sub-repository configured to facilitate storage of an independent copy of said content for use in a particular course.

5. The system of claim 4, wherein said sub-repository is configured to facilitate selective sharing of said independent copy of said content.

6. The system of claim 1, wherein said content delivery template is configured to facilitate private branding of said content.

7. The system of claim 1, wherein said content delivery template is configured to facilitate at least one of selective acceptance, rejection, and deferment of published updates of at least one of template branding and content versions.

8. The system of claim 1, wherein said permissions system is configured to enable administrative locking of said content within a course to prevent at least one of modification, hiding, and deletion of said content within said course.

9. The system of claim 1, wherein said content repository is configured to facilitate at least one of archival and retrieval of disparate content versions.

10. The system of claim 1, wherein said content repository search engine facilitates content searches based on at least one of author, contributor, publisher, topic, keyword, and creation date metadata associated with said content.

11. The system of claim 1, further comprising a workflow system configured to facilitate assignment of a plurality of tasks and provision of a plurality of task-related notices to users relative to content to be stored in said repository.

12. The system of claim 1, wherein said content repository search engine is configured to display a preview of at least one of selected content, content metadata, content usage, and content permissions.

13. The system of claim 1, wherein said content usage tracking engine is configured to facilitate correlation of learning outcome metadata associated with said content and student performance relative to a learning outcome.

14. The system of claim 1, further comprising a student portfolio and wherein said content usage tracking engine is configured to populate said student portfolio with data corresponding to student activity relative to said content, said data including content version data.

15. A method of facilitating the management of content at a central repository comprising:
associating metadata with said content defining a plurality of content characteristics;
indexing said content within said central repository based on said metadata;
publishing said content for use by multiple users;
providing a delivery template for assembly of content within a course;
establishing a reference to said content within said delivery template;
tracking a plurality of instances of content among a plurality of courses; and
updating said plurality of instances of content using said references across said plurality of courses.

16. The method of claim 10 further comprising:
tracking student activity relative to said instances of content among said plurality of courses; and
recording information from said tracking of student activity identifying at least one of the time and duration of said student activity relative to said instances of content.

17. The method of claim 16, wherein said recording step includes recording version data for said content upon which said student activity is based.

18. The method of claim 10, further comprising reporting student performance as a function of said student activity and learning outcome metadata associated with said content.

19. The method of claim 10, further comprising providing a report of content instances across said plurality of courses.

20. The method of claim 10, further comprising publishing updates to said content to a plurality of delivery templates referencing said content.

21. The method of claim 10, further comprising providing notices regarding the availability of updates to content referenced in a course.

22. The method of claim 21, further comprising providing users an option to at least one of accept, decline, and defer said updates.

23. The method of claim 15, further comprising executing a search for content in said content repository based on at least one of author, publisher, topic, keyword, and creation date metadata associated with said content.

24. The method of claim 10, further comprising assigning varying rights to manage content based upon established user role types.

25. The method of claim 10, further comprising providing an option to designate content for mandatory inclusion in a course by locking said content to prevent at least one of unauthorized modification, hiding, and deletion of said content within said course.

26. The method of claim 10, further comprising updating content within a plurality of delivery templates based upon changes made to content at said central repository.

27. The method of claim 10, wherein said providing a delivery template includes providing an option to apply private branding to said content delivery template.

28. The method of claim 10, further comprising providing capabilities for at least one of importing content into and exporting content from said content repository in at least one of SCORM, IMS, AICC, Microsoft Office, Macromedia, and Adobe compliant files.

29. The method of claim 10, further comprising uploading into said central repository a group of related content files as an HTML zip file.

30. A machine-readable medium having stored thereon a plurality of instructions, said plurality of instructions when executed by a processor, cause said processor to perform a method comprising the steps of:
associating metadata with said content defining a plurality of content characteristics;
indexing said content within said central repository based on said metadata;
publishing said content for use by multiple users;
providing a delivery template for assembly of published content within a course;
establishing a reference to said content within said delivery template;
tracking a plurality of instances of content among a plurality of courses; and
updating said plurality of instances of content across said plurality of courses.
